(19) United States
(12) Patent Application Publication
(10) Pub. No.: US 2004/0064441 A1
(43) Pub. Date: Apr. 1, 2004

(54) Systems and methods for providing structured query language optimization

(76) Inventor: Daniel S. Tow, Palo Alto, CA (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/256,936

(22) Filed: Sep. 27, 2002

(51) Int. Cl. G06F 17/30; G06F 7/00

(52) U.S. Cl. 707/2

(57) ABSTRACT

Systems and methods for organizing a structured query language statement execution plan to increase the efficiency of a computer device in executing the statement. A data structure is created in computer memory that encodes information about a database statement execution plan (e.g., an SQL statement). The information is arranged in a specific logical structure and may be displayed graphically as a query diagram. The data structure is used in optimizing the SQL statement execution plan so as to merge joined tables to enable efficient optimization. Furthermore optimized SQL execution plans in accordance with the present invention proportionally scale with the number of rows returned from a query, do not depend unnecessarily on potentially unavailable central resources (e.g., sort space), scale in the event that optimizer statistics and assumptions are poor, and make use of processing and memory resources.

### BACKGROUND OF THE INVENTION

1. Field of the Invention

The present invention relates to systems and methods for providing structured query language optimization. More particularly, the present invention relates to systems and methods for organizing a structured query language execution plan to increase the efficiency of a computer device in executing a statement.

2. Background and Related Art

Databases have been developed as collections of information that are organized so that a computer program may selectively obtain pieces of data from a particular collection. One type of database includes fields (single pieces of information), records (complete sets of fields), and files (collections of records). This type of database is particularly useful in performing numerical analysis. Another type of database includes objects (e.g., text, graphics, etc.), wherein any object may be linked to any other object. This type of database is particularly useful in organizing large amounts of disparate information. A third type of database includes an arrangement of rows and columns in a table format. This type of database is particularly useful in relational database management systems, wherein a comparison of data creates relationships between files. Thus, for example, any two or more files can be taken and a new file generated from the records that meet particular matching criteria.

A structured query language (“SQL”) is used to query or request information from a given database. SQL was originally developed in association with minicomputers and mainframes, but has more recently been supported by personal computer database systems since it supports databases that are spread out over several computer systems. Now all database systems designed for client/sever environments support SQL.

SQL commands are used to work interactively with a database or are embedded within a programming language to interface with a database. Programming extensions to SQL have evolved it into a full-blown database programming language, and all major database management systems support the language.

While techniques currently exist that are used to query or request information from a given database, routine queries often involve more than one data file and can be very slow. Accordingly, it would be an improvement in the art to augment or even replace current techniques with other techniques.

### SUMMARY OF THE INVENTION

The present invention relates to systems and methods for providing structured query language optimization. More particularly, the present invention relates to systems and methods for organizing a structured query language execution plan to increase the efficiency of a computer device in executing a statement.

Implementation of the present invention takes place in association with a computer device that employs an SQL statement to selectively access information from a database system. A data structure is created in computer memory that encodes information about an SQL statement. The information is arranged in a specific logical structure and may be displayed graphically as a query diagram. The data structure serves as a map of the SQL statement.

The data structure/query diagram is used in optimizing the SQL statement execution plan so as to use nested loops that avoid Cartesian products and to avoid most full-table scans. Furthermore, optimized SQL execution plans in accordance with the present invention proportionally scale with the number of rows returned from a query, do not depend unnecessarily on potentially unavailable central resources (e.g., sort space), scale in the event that optimizer statistics and assumptions are poor, and make use of processing and cache resources.

In one implementation of the present invention, for any given n-way join, in polynomial-n time, the fastest plan is determined that uses nested-loops to follow a join tree, which is the data structure/query diagram and comprises a representation of nodes. Each node of the join tree represents a table in a database. Each link represents a join between two linked tables. Also included in the data structure is a representation of a set of properties of the nodes and links. The properties include a set of zero or more factors for each node or for each end of each link. Each factor indicates a property of the table or of the join, in the context of the query, represented by the node that satisfies one or more logical conditions set forth in the data access statement (e.g., filters).

The factors may include a selectivity factor, a join filter factor, and a join cost factor. The selectivity factor indicates the relative desirability of joining to that node earlier in the execution plan, rather than later. The join filter factor is the expected ratio of rows after the join to rows before the join, where the estimate of rows after the join is reduced according to the expected selectivity of any query filter condition on the joined-to table. The join filter factor for a detail joined-to table may be more than one, reflecting how many detail table records match an average master table record, after discarding details that do not satisfy the query conditions. The join filter factor for a master joined-to table is not more than one, since there is not more than one master record per detail. The join cost is the expected cost of finding the matching joined-to-table records per average joined-from-table record in any convenient, consistent units (e.g., microseconds of processing time).

Accordingly, in at least one implementation, a process of utilizing the data structure/query diagram to optimize a particular query comprises identifying leaf nodes of the join tree, examining the exclusive parents of the leaf nodes, selectively merging the nodes where merging opportunities exist, calculating combined factors for the merged nodes, and determining a best result as to the order in which the joins to the nodes should be executed.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked system that enables a client computer device to selectively access information from a database system located at a server system;

FIG. 3 provides a representative embodiment for optimizing a join tree in accordance with the present invention; and

FIGS. 4A-4D provide a representative join tree that is optimized through methods of the present invention.

### DETAILED DESCRIPTION OF THE INVENTION

The present invention relates to systems and methods for providing structured query language optimization. More particularly, the present invention relates to systems and methods for organizing the execution of a structured query language statement to increase the efficiency of a computer device in executing a statement.

Embodiments of the present invention embrace a computer device that employs an SQL statement to access selectively information from a database system. In at least some embodiments of the present invention, the structured query language statement (“SQL”), which comes from outside of the database system, is not changed. Instead, the best possible plan-of-attack is developed to return the results that the SQL requests. However, in at least one embodiment, the desired execution plan is achieved by changing the SQL to force the RDBMS to use the right plan.

In one embodiment, a data structure is created in computer memory that encodes information about an SQL statement. The information is arranged in a specific logical structure and may be displayed graphically as a query diagram. The data structure serves as a map of the SQL statement.

The data structure/query diagram is used in optimizing the SQL statement so as to use nested loops that avoid Cartesian products and to avoid most full-table scans. Furthermore, optimized SQL execution plans in accordance with the present invention proportionally scale with the number of rows returned from a query, do not depend unnecessarily on potentially unavailable central resources (e.g., sort space), scale in the event that optimizer statistics and assumptions are poor, and make use of processing and cache resources.

In one embodiment for a given n-way join in polynomial-n time, the fastest plan is determined that uses nested-loops to follow a join tree, which is the data structure/query diagram that comprises a representation of nodes and links. Each node of the join tree represents a table in a database. Each link represents a join between two linked tables, usually having a master-detail relationship, which can optionally be represented by an arrow pointing toward the master table. Also included in the data structure is a representation of a set of properties, or factors, of the nodes and links.

The factors include a selectivity factor, a join filter factor, and a join cost factor. The selectivity factor indicates the relative desirability of joining to that node earlier in the execution plan, rather than later. The join filter factor is the expected ratio of rows after the join to rows before the join, where the estimate of rows after the join is reduced according to the expected selectivity of any query filter condition on the joined-to table. The join filter factor for a detail joined-to table can be more than one, reflecting how many detail table records match an average master table record, after discarding details that do not satisfy the query conditions. The join filter factor for a master joined-to table is not more than one, since there is not more than one master record per detail. The join cost is the expected cost of finding the matching joined-to-table records per average joined-from-table record, in any convenient, consistent units (e.g., microseconds of processing time). In this embodiment, the joined-from table is referred to as the parent, and the joined-to table is referred to as the child, following the hierarchy of the tree, where the chosen top node is referred to as the root.

The following disclosure of the present invention is grouped into two subheadings, namely “Exemplary Operating Environment” and “Optimizing a Database Query.” The utilization of the subheadings is for convenience of the reader only and is not to be construed as limiting in any sense.

### Exemplary Operating Environment

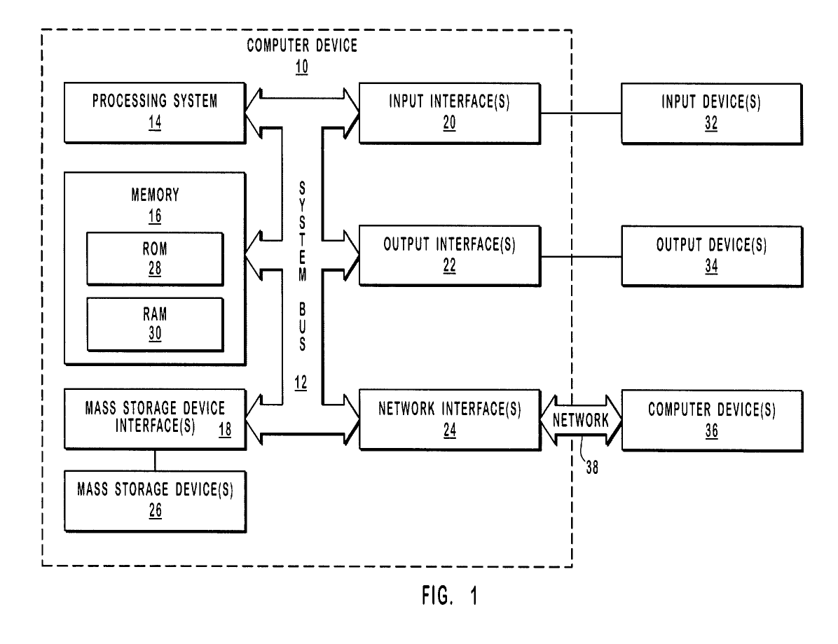

As embodiments of the present invention embrace a computer device that employs and optimizes an SQL statement to selectively access information from a database system, FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used temporarily to store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

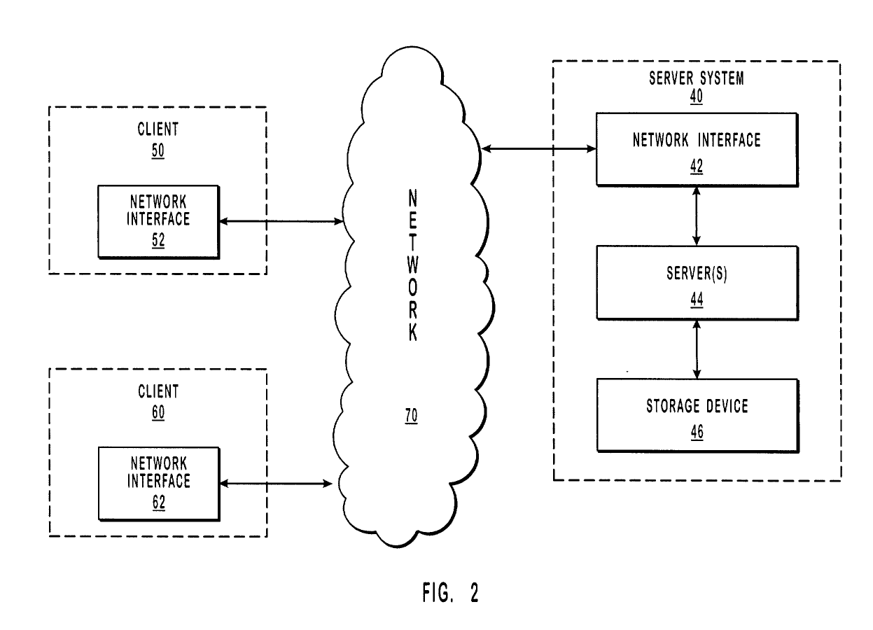

While those skilled in the art will appreciate that the invention may be practiced in networked computing environments with many types of computer system configurations, FIG. 2 represents an embodiment of the present invention in a networked environment that includes a two clients connected to a server via a network. While FIG. 2 illustrates an embodiment that includes two clients connected to the network, alternative embodiments include one client connected to a network or more than two clients connected to the network, including a multitude of clients throughout the world connected to a network, where the network is a wide area network, such as the Internet.

In FIG. 2, a representative networked configuration is provided for which SQL optimization occurs. Server system 40 represents a system configuration that includes one or more servers that selectively manage or process data located in one or more databases preserved in one or more storage devices. Accordingly, server system 40 includes a network interface 42, one or more servers 44, and a storage device 46. A plurality of clients, illustrated as clients 50 and 60, communicate with server system 40 via network 70, which may include a wireless network, a local area network, and/or a wide area network. Network interface 42 is a communication mechanism that allows server system 40 to communicate with one or more clients via network 70. Servers 44 include one or more servers for processing and/or preserving information. Storage device 46 includes data corresponding to one or more databases that may be selectively accessed by a request made by a client.

### Optimizing a Database Query

As provided above, embodiments of the present invention take place in association with a computer device that employs an SQL statement to selectively access information from a database system. While the examples provided herein relate to an SQL statement, those skilled in the art will appreciate that SQL is just one example of a database-query language, and that embodiments of the present invention embrace all types of database-query languages and optimizing all types of database queries regardless of the language employed.

The following discussion is intended to provide disclosure relating to optimizing a structured query language statement execution plan to increase the efficiency of a computer device in executing a statement.

A data structure is created in computer memory and encodes information about an SQL statement. The information is arranged in a specific logical structure and may be displayed graphically as a query diagram. The data structure serves as a map of the SQL statement and is used in optimizing the SQL statement execution plan so as to use nested loops joining tables in optimal order while avoiding Cartesian products and while avoiding most full-table scans. The optimized SQL statement execution plan proportionally scales with the number of rows returned from a query, does not depend unnecessarily on potentially unavailable central resources (e.g., sort space), scales in the event that optimizer statistics and assumptions are poor, and makes use of processing and cache resources.

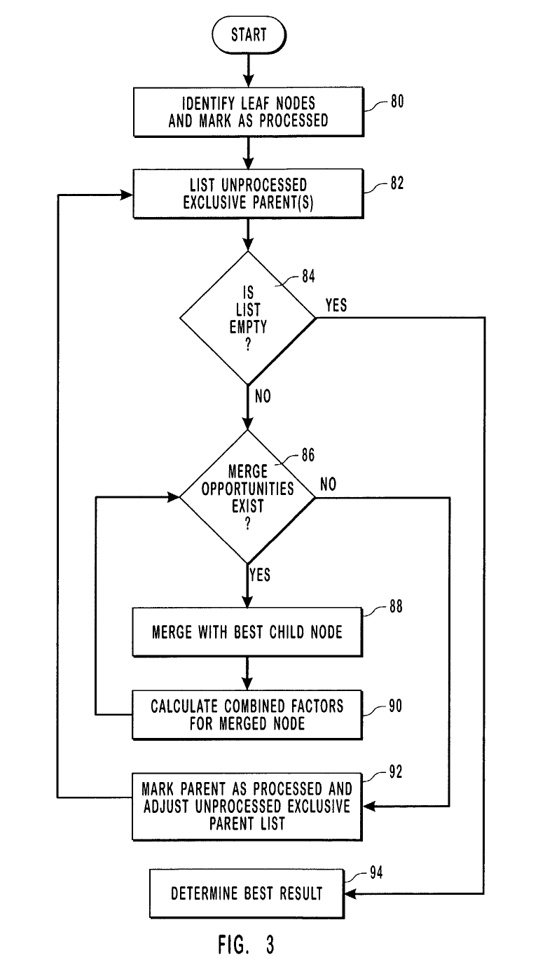

With reference now to FIG. 3, a flow chart is illustrated that provides a representative embodiment for optimizing an SQL statement execution plan in accordance with the present invention. In FIG. 3, execution begins at step 80 where leaf nodes of a tree structure are identified and marked as processed, wherein the term “processed” refers to having no potential for useful merges with child nodes, in this case because they have no child nodes. The leaf nodes of the tree structure are the nodes that do not have a node attached below them. (Nodes are defined as being “above” a given node N when one must go through those nodes to follow a chain of links from N to the root node, the node that one proposes reading first in the nested-loops execution plan. For two nodes directly joined by a single link, the node above is the “parent” node, and the node below is a “child” node of that parent node.)

At step 82, the unprocessed exclusive parents of the nodes are listed. Unprocessed exclusive parents are defined as parent nodes having no unprocessed child nodes, excluding the root node at the top of a join tree. Execution then proceeds to decision block 84 for a determination as to whether the list of unprocessed exclusive parents is empty (i.e., if all nodes except the root node are processed). If it is determined at decision block 84 that the list is empty, execution proceeds directly to step 94, where the best result is determined.

Alternatively, if it is determined at decision block 84 that the list is not empty, execution proceeds to step 86 for a determination as to whether or not merge opportunities exist in the form of child nodes with higher or equal selectivity factors than the selectivity factor of the parent node currently under consideration. Merge opportunities exist, for example, when the best child node (i.e., the child node with the highest selectivity factor) has a selectivity factor of at least as high as the parent node. If it is determined at decision block 86 that additional merge opportunities exist for the current parent node, the best child node is merged with the current parent node at step 88, and the combined factors for the merged node (i.e., the selectivity factor “Q”, the join filter factor “F”, and the join cost factor “M”) at step 90. Execution then returns back to decision block 86 for a determination as to whether or not additional merge opportunities exist.

When it is determined at decision block 86 that no merge opportunities exist for the current parent, execution proceeds to step 92, where the current parent lacking further merge opportunities is marked as processed and removed from the list of unprocessed exclusive parents. The parent of the just-processed node is checked to see if it now lacks unprocessed children. If it lacks unprocessed children and it is not the root node, it is added to the list of unprocessed exclusive parents. Execution then returns back to step 82 with the newly modified list of unprocessed exclusive parents until the list is empty, wherein execution then proceeds to step 94.

At step 94, the processed nodes are ordered in selectivity-factor order, and an execution plan is chosen that joins to high-selectivity-factor processed nodes before joining to lower-selectivity-factor processed nodes. In the event of equal selectivity-factors between parent nodes and their child nodes, the join to parents is ordered first. This latter possibility is excluded if child nodes having selectivity factors equal to (as well as greater than) the selectivity factor for their parent are merged, ensuring that child nodes not merged with the corresponding parent node following the merge steps always have lower selectivity factors than their corresponding parent nodes. Processing for step 94 determines the global join order to single-table nodes by the order of the nodes within the merged nodes, parents before children, children with higher selectivity factors before children with lower selectivity factors. Since merged nodes can themselves merge with merged children, recursively, this last step to determine the global join order is equivalent to flattening a list of lists, or stripping away nested parentheses in a list that might include merged nodes that are themselves parenthetical lists.

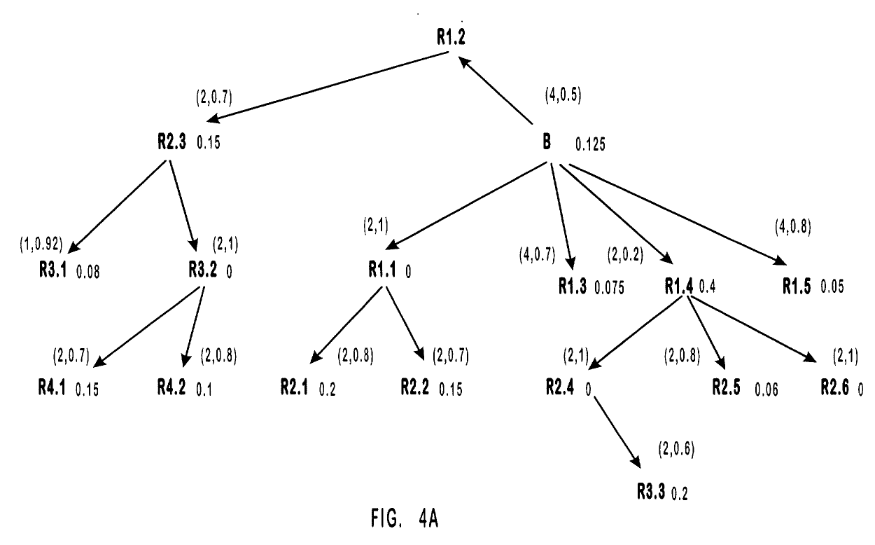

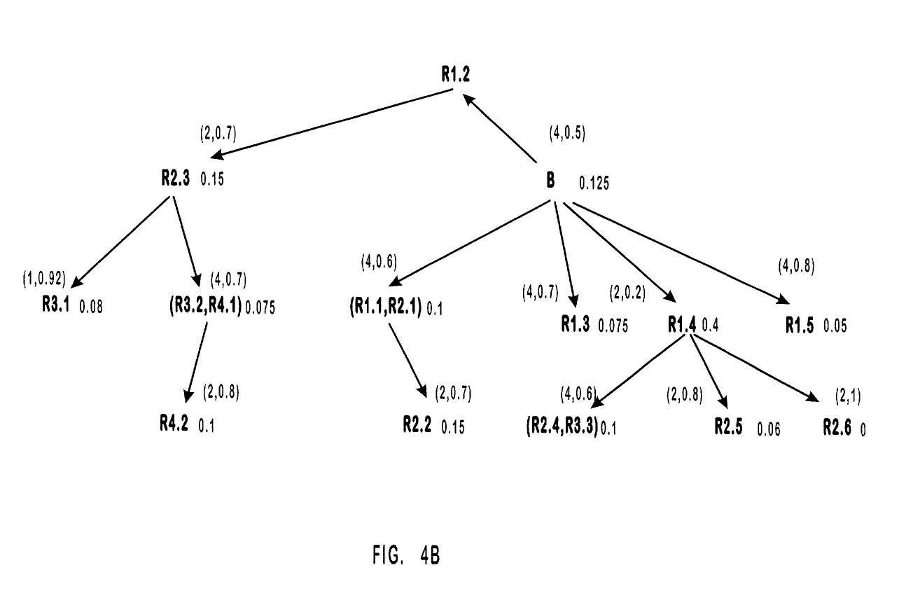

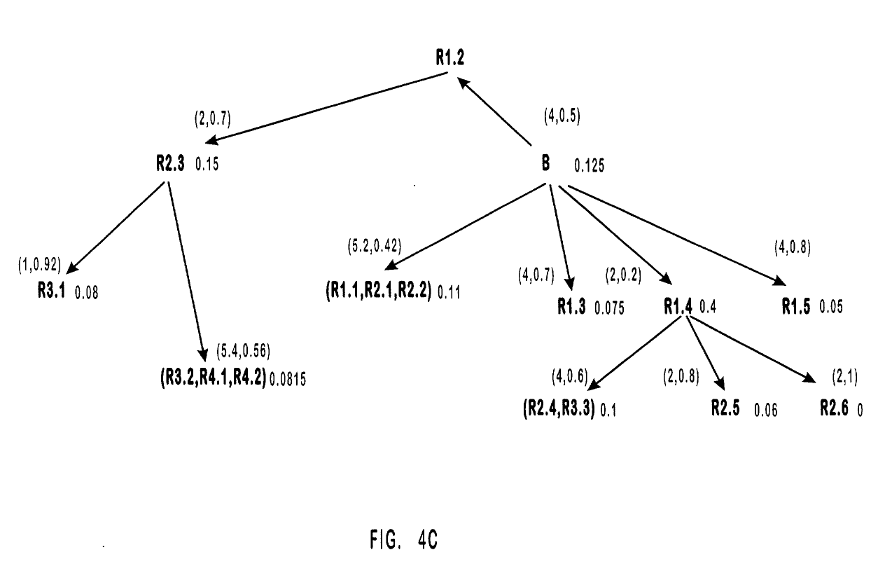

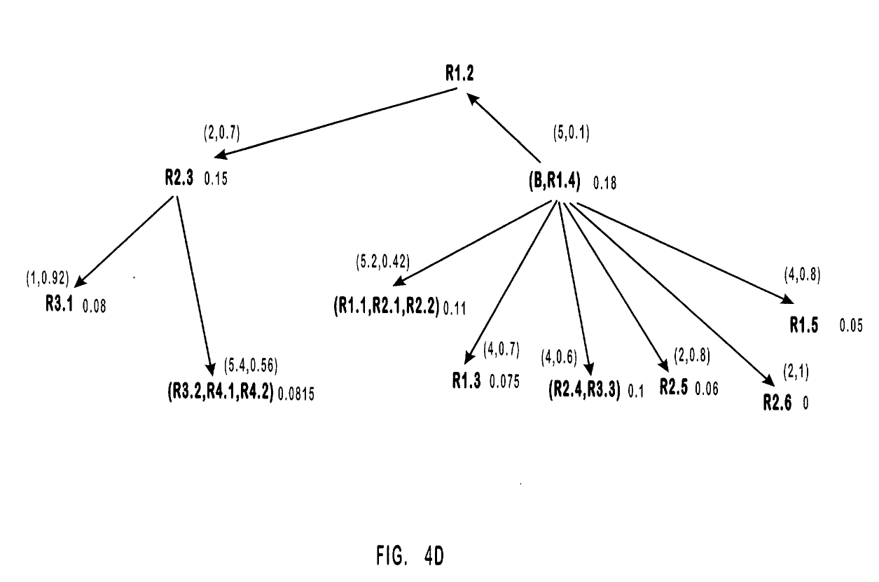

Each of these steps and decisions will be closely examined in the following representative example corresponding to FIGS. 4A-4D, wherein an SQL join tree is illustrated and optimized to increase the efficiency of a computer device in executing the SQL statement.

In one embodiment, for any given n-way join, the fastest plan that uses nested-loops to follow a join tree is rapidly determined. The nested-loops minimize the amount of memory required. The join order determined minimizes the processing cost required, given the chosen root or driving table of the execution plan.

With reference now to FIG. 4A, a representative join tree is illustrated having nodes B, R1.1, R1.2, R1.3, R1.4, R1.5, R2.1, P2.2, P2.3, P2.4, R2.5, P2.6, R3.1, R3.2, R3.3, R 4.1, and R4.2. Each node of the join tree illustrated in FIG. 4A represents a table in a database. Each link (i.e., each arrow illustrated from one node to another node, wherein the directionality of the arrow is immaterial to the illustrated embodiment) represents a master-detail relationship between two joined tables. Also illustrated in the join tree is a representation of a set of properties of the nodes and links. The properties include a selectivity factor for each node other than the root node at the top of the join tree, where the root node represents the table already chosen at least tentatively as the first table reached in the execution plan. The selectivity factors are illustrated as numbers without parentheses. Thus, for example, the selectivity factor for node R2.3 is 0.15. Each selectivity factor indicates the relative desirability (on a stand-alone basis, without considering child-node properties) of joining to that node earlier in the execution plan, rather than later.

The properties also include the join filter factor and the join cost. The join filter factor is the expected ratio of rows after the join to the child to rows before the join, wherein the estimate of rows after the join is reduced according to the expected selectivity of any query filter condition on the child. The join filter factor for a detail child table can be more than one, reflecting how many detail table records match an average master table record, after discarding details that do not satisfy the query conditions. The join filter factor for a master child table is never more than one, since there is never more than one master record per detail. The join cost is the expected cost of finding the matching child-table records per average parent-table record, in any convenient, consistent units (e.g., microseconds of processing time). Strictly speaking there are join filter factors and join cost factors for both ends of a join link, but given a choice of root node, which determines which end of a link is the parent and which end is the child, the only join filter factors used by an embodiment of the present invention are the join filter factors on the child end of the link, which can then be viewed as properties of the child node, itself. The selectivity factor, the join filter factor on the child end of the join, and the join cost factor on the child end of the join are collectively referred to as the factors of the child node. Thus, for node R2.3, the cost of finding any row or rows in the table R2.3 that join to an average row in table R1.2 is 2 and the expected row count after the join to R2.3, after discarding rows that fail to satisfy filter conditions on table R2.3, is 0.7 times the pre-join row count.

Thus, the join cost and filter factors (the number illustrated in parenthesis) may be mathematically represented as (M(i), F(i)), wherein M(i) is the cost of joining from a row on the parent side of the join to as many rows as match on the child side of the join, usually using the index on the child-table join key, and wherein F(i) is the ratio of the number of rows left after the join, over the number of rows before the join. In addition, the selectivity factor (Q(i)) may be mathematically calculated as Q(i)=(1−F(i))/M(i).

Therefore, a data structure or join tree is created for use in selecting an execution plan for a data access statement, given a choice, or at least a tentative choice, of the driving table, the first table to access in the execution plan, which we place at the root (top) of the join tree. Examples of data access statements include statements such as SELECT statements in the well-known Structured Query Language (SQL). Since the methods and processes of the present invention are language-independent, other data-access languages can be used in connection with embodiments of the present invention.

The data access statement specifies (i) a plurality of tables, (ii) a plurality of join conditions, and (iii) zero to many filter conditions, which specify conditions on the desired table rows. A join condition usually specifies a relationship between a table that uses a key as a primary key, referred to as a master table, and a table that uses a corresponding key as a foreign key, referred to as a detail table. A primary key for a given table is a key that can take on a variety of values, but each individual value appears no more than once in that table. A foreign key is a value that exists in a table and which references a primary key, usually in another table.

While reference is made herein to joins being master-detail, embodiments of the present invention embrace joins that are not master-detail. Accordingly, some embodiments embrace the use of pairs of joined tables (e.g., one parent and one child, depending on which table is chosen as the driving table) and joined keys. As indicated above, a set of nodes (nodes B, R1.1, R1.2, R1.3, R1.4, R1.5, R2.1, R2.2, R2.3, R2.4, R2.5, R2.6, R3.1, R3.2, R3.3, R 4.1, and R4.2) respectively representing the tables is defined.

In a memory device, a data structure (join tree) is defined and comprises a representation of the nodes and their join links. The logical structure may be depicted graphically as a directed graph such as shown in FIG. 4A.

In accordance with embodiments of the present invention, methods are provided to optimize selectively the SQL statement execution plan. First the leaf nodes of the illustrated join tree are identified and marked as processed nodes. In particular, the leaf nodes are nodes R3.1, R4.1, R4.2, P2.1, R2.2, R1.3, R3.3, R2.5, R2.6 and R1.5.

The corresponding unprocessed exclusive parent nodes (nodes that have only processed children and that are not the root node) are then examined. In the illustrated embodiment, the unprocessed exclusive parent nodes are R3.2, R1.1, and R2.4.

A merge is then performed with the best direct child node if that child node is not worse that the corresponding exclusive parent. In the illustrated embodiment, the selectivity factor (Q) of the exclusive parent nodes R3.2, R1.1, and R2.4 is zero. The best direct child node corresponding to the exclusive parent nodes is the direct child node having the highest selectivity factor (Q), wherein the selectivity factor of the child is higher than the selectivity factor of the parent. Thus, relating to exclusive parent node R3.2, the best direct child node is R4.1, since it has a higher selectivity factor than R4.2. Similarly, relating to exclusive parent node R1.1, the best direct child node is R2.1, since it has a higher selectivity factor than R2.2. In addition, relating to exclusive parent node R2.4, the best direct child node is R3.3 because it is the only child node of R2.4.

Combined factors for the merged nodes (the exclusive parent and corresponding best direct child node) are calculated. This calculation is represented mathematically in the following manner:

F(total)=F(parent)*F(child)

M(total) M(parent)+(F(parent)*M(child))

Q(total) (1−F(total))/M(total)

Thus, the modified join tree that reflects the merging of the parent and the best child nodes, so far, is illustrated in FIG. 4B. At this point, the child nodes are again identified and the exclusive parents are examined. The remaining child nodes for the first set of parents being processed of FIG. 4B are nodes R4.2 and R2.2 for the parents [R3.2,R4.1] and [R1.1,R2.1]. The node [R2.4,R3.3] has no more child nodes, so it is marked as processed and removed from the unprocessed exclusive parents list. R1.4 joins the exclusive parents list, since all the corresponding child nodes, [R2.4,R3.3], R2.5, and R2.6, are now processed. No merge opportunities exist for R1.4, since all the child nodes of R1.4 have lower selectivity factors than R1.4, so it is immediately marked as processed. R1.4 is removed from the unprocessed exclusive parents list. The parent of R1.4 does not yet join the unprocessed exclusive parents list because the child node [R1.1,R2.1] is not yet fully processed. The unprocessed exclusive parents [R3.2,R4.1] and [R1.1,R2.1] both still have merge opportunities, remaining child nodes R4.2 and R2.2, respectively having higher selectivity factors than the corresponding parents, so a merge is performed for each of these parent nodes with the corresponding child nodes. Accordingly, the combined factors are calculated for the merged nodes again by the use of the following mathematical expressions:

F(total)=F(parent)*F(child)

M(total)=M(parent)+(F(parent)*M(child))

Q(total)=(1−F(total))/M(total)

The recently merged nodes [R3.2,R4.1,R4.2] and [R1.1,R2.1,R2.2] have no more merge opportunities and are therefore marked as processed and removed from the list of unprocessed exclusive parents. The parents of these recently processed nodes are R2.3 and B, and these are added to the list of unprocessed exclusive parents because they now have only processed child nodes. With reference now to FIG. 4C, the modified join tree that reflects the recent merging of the parent and child nodes is illustrated. In the illustrated embodiment, no merge opportunities exist for R2.3 since the corresponding child nodes all have selectivity factors lower than 0.15, the selectivity factor for R2.3. Accordingly, R2.3 is marked as processed and is removed from the list of unprocessed exclusive parents. The best merge opportunity for the single remaining unprocessed exclusive parent node B is processed child node R1.4, which has a selectivity factor, 0.4, higher than the selectivity factor 0.125 of the parent node B, so it is eligible to be merged. Accordingly, it is merged and the combined factors are calculated for the merged node again by the use of the following mathematical expressions:

F(total)=F(parent)*F(child)

M(total) M(parent)+(F(parent)*M(child))

Q(total)=(1−F(total))/M(total)

The child nodes of the recently merged child node R1.4 are promoted to become child nodes of the merged node [B,R1.4]. The list of child nodes of the merged node [B,R1.4] is now [R1.1,R2.1,R2.2], R1.3, [R2.4,R3.3], R2.5, R2.6, R1.5. At this point, the merged join tree appears as in FIG. 4D. The list of child nodes of [B,R1.4] is examined to determine if it contains a merge opportunity, but it does not since no child node on the list has a higher selectivity factor than the selectivity factor 0.18 of the parent node [B,R1.4]. Accordingly, [B,R1.4] is marked as processed and removed from the unprocessed exclusive parent list. The only remaining unprocessed node, R1.2, is the root node and is therefore ineligible for merging, so the unprocessed exclusive parent list is empty.

Thus, the modified join tree that reflects the merging of the nodes is illustrated in FIG. 4D. At this point no more merge opportunities exist since no child node has a selectively factor (Q) that is greater than the selectivity factor of the corresponding parent. Accordingly, and with reference to step 94 of FIG. 3, a determination is made as to the best result or optimum join order for a fully merged complex join tree. In one embodiment, the joining occurs such that (i) a join includes a parent node before joining to its child node, and (ii) that a join is made by descending order of the selectivity factor (Q), since the descending order does not violate the constraints on a fully merged complex join tree and results in a minimum-cost execution plan. In another embodiment the joining occurs such that a join is made by descending order of the selectivity factor (Q), since the descending order does not violate the constraints on a fully merged complex join tree. In this embodiment, merging has already ensured that child nodes having equal or greater selectivity factors with their parent nodes have been merged with their parent nodes, which ensures that any join of merged nodes in descending order automatically joins to parent nodes before it joins to their child nodes.

Thus applying the two elements of joining order to the present embodiment such that straight descending order is performed and that the selectivity factors are considered, the best result for joining the various nodes begins at the root of the tree (node R1.2) and then to the node having the greater selectivity factor. Since [B,R1.4] has the greatest selectivity factor (0.18), it is joined first and then the node having the next highest selectivity factor (node R2.3 having a selectivity factor of 0.15) is joined. Both can be joined since their parent node (R1.2) had previously been accessed. The next node that is joined is the node having the next highest selectivity factor, which is [R1.1,R2.1,R2.2] having the selectivity factor of 0.11. The next node joined is node [R2.4,R3.3], which has the next highest selectivity factor of 0.1. The next node joined is node [R3.2,R4.1,R4.2], which has the next highest selectivity factor of 0.0815. The next node joined is node R3.1, which has the next highest selectivity factor of 0.08. The next node joined is node R1.3, which has the next highest selectivity factor of 0.075. The next node joined is node R2.5, which has the next highest selectivity factor of 0.06. The next node joined is node R1.5, which has the next highest selectivity factor of 0.05. The last node joined is node R2.6, which has the lowest selectivity factor of 0. Accordingly, the best result referring still to the merged nodes is the following sequence: R1.2, [B,R1.4], P2.3, [R1.1,R2.1,R2.2], [R2.4,R3.3], [R3.2,R4.1,R4.2], R3.1, R1.3, P2.5, R1.5, and R2.6.

Processing for step 94 determines the global join order to single-table nodes by the order of the nodes within the merged nodes, parents before children, leaving merged node groups where they already are, effectively stripping the parentheses from the merged-node sequence. Accordingly, the best result expressed as a global join order is the following sequence: R1.2, B, R1.4, R2.3, R1.1, R2.1, R2.2, R2.4, R3.3, R3.2. R4.1, R4.2, R3.1, R1.3, R2.5, R1.5, and R2.6. In fact, it is determined that this sequence is the best result out of 20,922,789,888,000 possible join orders. Accordingly, the systems and methods of the present invention optimize the SQL statement execution plan and streamline use of processing and memory resources.

Another embodiment of the present invention contemplates the consideration of a plurality of driving tables. Accordingly, the methods and processes discussed herein may be repeated on the plurality of driving tables. Thus, in a further embodiment, strategies are used to eliminate most possible driving tables, including: (i) starting with the table that has the best filter fraction, (ii) first converting outer joins to inner joins where the outer case is discarded, (iii) resisting driving from tables that are lacking indexed paths that reach the rest of the join tree, and (iv) resisting driving from leaf branches without filters, and (v) resisting driving from tables that cost more to drive into directly than the entire best-cost alternative already calculated assuming different driving tables.

In another embodiment, strategies are used to save work to examine new driving tables, including (i) saving collapsed-node results from mergings and sorts with different driving tables (merging for every driving table costs no more than two times as much as merging for a single driving table) and (ii) bailing out as soon as partial cost exceeds the best alternative cost.

In another embodiment, where there is no useful strategy, the examination of n possible driving tables is only n times as difficult as examining one.

In another embodiment, single-row-filtered branches are pre-stripped to enable the use of a safe Cartesian product.

In yet another embodiment, a merge is performed on unfiltered peer leaf nodes and branches or on peers that otherwise have equal selectivity factors.

Thus, in accordance with the present invention, a best execution plan is found for each proposed driving table considered, and the overall best execution plan is chosen. Having found the best nested-loops plan, in one embodiment the robust-plans requirement is relaxed for each joined-to table, replacing nested loops through the join index with independent-table access and hash joins. If the cost for any single table decreases, that alternate path to that table at that point in the join order may be used, leaving the rest of the path to the other tables unaltered. A new tree may also be considered having lower per-row costs (not counting the fixed table-I/O cost) for those joins. An iteration process occurs until the plan does not change any more.

Accordingly, at least some of the embodiments of the present invention utilize values, called selectivity factors, that are derived from the conditions on the tables, the nature of the joins, and statistical properties of the tables and the indexes, and which represent the relative attractiveness of performing each relevant join early, rather than later, given that a table is being joined through a particular join key. The best later-table join order is determined, given a driving table, by first merging certain neighboring tables and table lists into merged table lists having new selectivity factors that derive from the same data that determined the separate selectivity factors of the two parts being merged, following a set of merging rules that specify when and in what order to merge tables and table lists, then sorting the fully merged tables and table lists according to the fully merged selectivity factors. The best overall join order is determined by calculating and comparing the full costs of the best plans for each of the driving tables capable of delivering good, robust plans, and choosing the overall join order delivering the best cost. Tables and table lists are merged from the bottom up, where the bottom is defined to be tables most-distant from the proposed driving table, in terms of the count of intervening joins. When merging a given parent table or table list, the child table or previously merged child table list that is merged next is the one with the highest (or at least tied for highest) selectivity-factor, repeating until no remaining child table has a better (or at least equal) selectivity factor compared to the selectivity factor of the Parent-table or table list that is being merged.

Thus, as discussed herein, the embodiments of the present invention embrace systems and methods for providing structured query language optimization. More particularly, the present invention relates to systems and methods for organizing a structured query language statement execution plan to increase the efficiency of a computer device in executing the statement. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for selectively optimizing a path to access information from a database system, the method comprising the steps for:
examining nodes for merge opportunities;
selectively merging nodes; and
selectively calculating values for the merged nodes.

2. A method as recited in claim 1, wherein the method further includes the step for identifying one or more child nodes as processed nodes.

3. A method as recited in claim 2, wherein the step for examining nodes comprises the step for examining exclusive parent nodes of the processed nodes.

4. A method as recited in claim 1, wherein the step for selectively merging nodes comprises the step for merging a most favorable child node with a parent node if a selectivity factor value of the most favorable child node is not less favorable than a selectivity factor value of the parent node.

5. A method as recited in claim 4, further comprising the step for merging one or more additional child nodes with the merged parent node, wherein a selectivity factor of each additional child node is not less favorable than the selectivity factor of the merged parent node.

6. A method as recited in claim 1, wherein the step for selectively calculating values for the merged nodes comprises at least one of the steps for:
determining a selectivity factor for the merged nodes;
determining a join filter factor that indicates an expected number of rows in a joined-to merged node that satisfy an average row in a joined-from table, wherein the expected number of rows corresponds to the merged nodes; and
determining a join cost factor to reach matching rows from the joined-to merged node corresponding to an average row from the joined-from table.

7. A method as recited in claim 6, wherein the selectivity factor of the merged nodes indicates a relative attractiveness of the merged nodes to appear earlier in a join order.

8. A method as recited in claim 1, wherein the step for selectively merging nodes comprises at least one of the steps for:
merging a downstream node with a direct parent node, wherein the downstream node has a greater selectivity factor than the direct parent node;
joining a first node to a first parent node before joining the first node to a child node of the first parent node;
if no downstream node has a selectivity factor that is greater than a selectivity factor of a corresponding parent node, joining nodes by descending order of corresponding selectivity factors; and
employing a straight descending order to join nodes.

9. A method as recited in claim 1, wherein the method does not modify a structured query language statement from outside of a database.

10. A method as recited in claim 1, further comprising the step for modifying a structured query language statement to force a relational database management system to use a particular plan.

11. A method as recited in claim 1, further comprising the steps for:
using the method on a plurality of driving tables; and
performing zero or more of the steps for:
identifying a first table that includes a best filter fraction;
converting outer joins to inner joins;
resisting driving from tables that are lacking indexed paths that reach the remainder of a join tree;
resisting driving from leaf braches without filters; and
resisting driving from tables that cost more to drive into directly than compared to an entire best-cost alternative that is calculated.

12. A method as recited in claim 1, further comprising at least one of the steps for:
examining a new driving table;
preserving collapsed-node results from mergings and sorts with different driving tables; and
no longer merging when a partial cost exceeds a best alternative cost.

13. A method as recited in claim 1, further comprising at least one of the steps for:
pre-stripping single row filtered branches to enable use of a Cartesian product; and
performing a merge on at least one of:
(i) unfiltered peer leaf nodes;
(ii) unfiltered branches; and
(iii) peers that have equal selectivity factors.

14. A computer program product for implementing within a computer system a method for optimizing a statement execution plan to access information, the computer program product comprising:
a computer readable medium for providing computer program code means utilized to implement the method, wherein the computer program code means is comprised of executable code for implementing the steps for:
examining nodes for merge opportunities;
selectively merging nodes; and
selectively calculating values for the merged nodes.

15. A computer program product as recited in claim 14, wherein the method further includes step for identifying leaf nodes as processed nodes.

16. A computer program product as recited in claim 14, wherein the step for examining nodes comprises the step for examining exclusive parent nodes of processed nodes.

17. A computer program product as recited in claim 14, wherein the step for selectively merging nodes comprises the step for merging a most favorable node with a parent node if a selectivity factor value of the most favorable child node is not less favorable than a selectivity factor value of the parent node.

18. A computer program product as recited in claim 17, wherein the computer program code means further comprises executable code for implementing the step for merging one or more additional child nodes with the merged parent node, wherein a selectivity factor of each additional child node is not less favorable than the selectivity factor of the merged parent node.

19. A computer program product as recited in claim 14, wherein the step for selectively calculating values for the merged nodes comprises at least one of the steps for:
determining a selectivity factor for the merged nodes;
determining a join filter factor that indicates an expected number of rows in a joined-to merged node that satisfy an average row in a joined-from table, wherein the expected number of rows corresponds to the merged node; and
determining a join cost factor to reach matching rows from the joined-to merged node corresponding to an average row from the joined-from table.

20. A computer program product as recited in claim 14, wherein the step for selectively merging nodes comprises at least one of the steps for:
merging a downstream node with a direct parent node, wherein the downstream node has a greater selectivity factor than the direct parent node;
joining a first node to a first parent node before joining the first node to a child node of the first parent node;
if no downstream node has a selectivity factor that is greater than a selectivity factor of a corresponding parent node, joining nodes by descending order of corresponding selectivity factors; and
employing a straight descending order to join nodes.
